(19) United States
(12) Patent Application Publication
(10) Pub. No.: US 2014/0268816 A1
(43) Pub. Date: Sep. 18, 2014

(54) LIGHTING FIXTURES AND METHODS FOR PROVIDING ILLUMINATION

(71) Applicant: SWAROVSKI LIGHTING, LTD., Plattsburg, NY (US)

(72) Inventor: Stefano Ricci, Roma (IT)

(73) Assignee: Swarovski Lighting, Ltd., Plattsburg, NY (US)

(21) Appl. No.: 13/795,272

(22) Filed: Mar. 12, 2013

(51) Int. Cl. F21V 1/00

(52) U.S. Cl. CPC F21V 1/00
USPC 362/311.13; 362/311.01

(57) ABSTRACT

A lighting fixture includes a cap and a spaced-apart shield. The cap is suspendable below a ceiling and disposed generally over a light source. The lighting fixture includes at least one of the shield having at least one aperture with at least one translucent ornament illuminatable by the light source, a plurality of elongated members connected at one end to the cap and at a second end to the shield to support an upper portion of the shield spaced apart from a lower portion of the cap, and the shield having a plurality of openings therethrough defining a pattern in the shield illuminatable by the light source.

### CROSS-REFERENCE TO RELATED APPLICATION

This application contains subject matter which is related to the subject matter of commonly assigned and co-filed U.S. Design patent application Ser. No. ______, entitled “Light Fixture” by Stefano Ricci, (atty. dock. no. 2350.3003), which is hereby incorporated in its entirety herein by reference.

### FIELD OF THE INVENTION

This present disclosure relates generally to lighting fixtures and methods for providing illumination.

### BACKGROUND OF THE INVENTION

Pendant lights are lighting devices that hang from a ceiling. Typically, a pendant light is supported from a ceiling mount by a cord, chain, or pipe with an upper end attached to the ceiling mount, and a lower end attached to the lighting device. Typically, the lighting device includes shade and a light such as a light bulb. The shade is often in the form of a bulbous glass shade, a cylindrical drum shade, or a conical shade.

There is a need for further lighting fixtures and methods for providing illumination.

### SUMMARY OF THE INVENTION

In a first aspect, the present disclosure provides a lighting fixture suspendable below a ceiling. The lighting fixture includes an opaque cap disposed generally over a light source and operably attachable below the ceiling, an opaque shield spaced apart below the cap in which the shield comprises at least one aperture, and at least one translucent ornament disposed in the aperture of the shield. Light emitted from the light source is directed generally towards the translucent ornament.

In a second aspect, the present disclosure provides a lighting fixture suspendable below a ceiling. The lighting fixture includes an opaque cap disposed generally over a light source and operably attachable below the ceiling, an opaque shield, and a plurality of elongated members connected at one end to the cap and at a second end to the shield to support an upper portion of the shield spaced apart from a lower portion of the cap.

In a third aspect, the present disclosure provides a lighting fixture suspendable below a ceiling. The lighting fixture includes an opaque cap disposed generally over a light source and operably attachable below the ceiling, an opaque shield spaced apart below the cap, and wherein the shield comprises a plurality of openings therethrough defining a pattern in the shield and the pattern being illuminatable by the light source.

In a fourth aspect, the present disclosure provides a method for providing illumination. The method includes emitting light onto a translucent ornament disposed in an aperture in a shield from an opaque cap suspended from a ceiling and spaced above the opaque shield.

### BRIEF DESCRIPTION OF THE DRAWINGS

The subject matter which is regarded as the disclosure is particularly pointed out and distinctly claimed in the concluding portion of the specification. The disclosure, however, may best be understood by reference to the following detailed description of various embodiments and the accompanying drawings in which:

FIG. 1 is a perspective view of one embodiment of a lighting fixture in accordance with aspects of the present disclosure;

FIG. 2 is a front elevational view thereof, a right side elevational view, a left side elevational view, and a rear elevational view being identical thereto;

FIG. 3 is a bottom view of the lighting fixture of FIG. 1;

FIG. 4 is an enlarged cross-sectional view of a portion of the lighting fixture of FIG. 1;

FIG. 5 is an enlarged cross-sectional view of the bottom of the cap of FIG. 4;

FIG. 6 is a front side elevational view of another embodiment of a lighting fixture in accordance with aspects of the present disclosure, a right side elevational view, a left side elevational view, and a rear elevational view being identical thereto;

FIG. 7 is a bottom view of the lighting fixture of FIG. 6;

FIG. 8 is a front side elevational view of another embodiment of a lighting fixture in accordance with aspects of the present disclosure, a right side elevational view, a left side elevational view, and a rear elevational view being identical thereto;

FIG. 9 is a bottom view of the lighting fixture of FIG. 8; and

FIG. 10 is a flowchart illustrating a method for providing illumination in accordance with aspects of the present disclosure.

### DETAILED DESCRIPTION OF THE INVENTION

FIG. 1 illustrates one embodiment of a lighting pendant 10 in accordance with aspects of the present disclosure. Lighting pendant 10 generally comprises a ceiling mount 12, a lighting fixture 20, and an elongated support 16 for suspending and supporting the lighting fixture below a ceiling. The lighting pendant may be operably connected to an electrical supply, for example, via an electrical cable running through the elongated support. The elongated support may be a hollow conduit or pipe. Alternatively, the lighting fixture may be suspended from an electrical cable or from one or more support wires.

Lighting fixture 20 may generally include an opaque cap 30, an opaque shield 50, a plurality of elongated members 70 connecting the cap to the spaced-apart shield, and at least one translucent ornament 80. Opaque cap 30 may be attachable to elongated support 16, and opaque cap 30 may be disposed or extend generally over a light source 18. Opaque cap 30 may include an upper portion 32 for inhibiting transmission of light from light source 18 upwardly, and opaque cap 32 may include a lower portion 34. The light source may be disposed entirely within opaque cap 30 or a portion, such as the lower portion of the light source, may be disposed below lower portion 34.

Opaque shield 50 may be spaced apart below opaque cap 30. Opaque shield 50 may comprise therein an aperture 51. Translucent ornament 80 may be disposed in aperture 51 of shield 50. Light emitted from the light source may be directed generally downwardly towards translucent ornament 80. The ornament may be of any available size. In one example, the ornament may have a length of about 4.3 inched, a width of about 4.3 inches, and a height of about 2 inches. Translucent ornament 80 may comprise a crystal ornament. In addition, the ornament may be a plurality of translucent ornaments.

Plurality of elongated members 70 may include an upper end 72 connectable to cap 30 and a second end 74 connectable to shield 50 to support an upper portion 52 of shield 50 spaced apart from lower portion 34 of cap 30. Elongated members 70 may comprise a plurality of curved elongated member, and the elongated members may be disposed along a non-vertical angle between the cap and the shield.

With reference to FIG. 2, shield 50 may comprise a first outer peripherally-extending edge 55, cap 30 may comprise a second outer peripherally-extending edge 35, and first outer peripherally-extending edge 55 may be larger than second outer peripherally-extending edge 35.

Cap 30 may have a height H1, shield 50 may have a height H2, and height H1 may be greater than such as about twice the height of height H2. Cap 30 may be spaced a vertical distance D from shield 50. Translucent ornament 80 may include a bottom portion 82 that extends a distance H3 below a bottom surface of shield 50. As shown in FIG. 4, cap 30 and shield 50 may be formed from a solid opaque material, or have a solid opaque outer or inner surface.

With reference still to FIG. 4, shield 50 may be connected to lower ends 74 of elongated members 70 by welding or other suitable attachment. Cap 30 may be connected to upper ends 72 of elongated members 70 by welding or other suitable attachment. The attachment of the ends of the elongated members may be generally obscured from view by observers. Ornament 80 may be operably retained in shield 50 by a plurality of suitable supports 82 and threaded fasteners. Upper portion 32 of cap 30 may have a thinner cross-section compared to the cross-section of lower portion 34 of cap 30. A plurality of plates 37 and 38 may extend across and be secured to the bottom of cap 30 with a plurality of screws 39.

As best shown in FIG. 5, lower portion 34 of cap 30 may include a recess defining a stop or landing 31 on which plate 37 rests. Plate 37 may be sized or peripheral portions sized so as to be spaced from an inner wall surface 33 of cap 30 and so that the distal portions of upper ends 72 of elongated members 70 may be disposed between the ends of plate 37 and inner wall surface 33. Distal portions of upper ends 72 of elongated members 70 may also include a cutout 35 for receiving portions of the peripheral end of plate 38 to thereby attach the upper ends of the elongated members to the cap. Plate 38 may include one or more separate plates. Light source 18 may be supported by a mounting unit 19 attached to the upper surface of plate 37.

FIG. 6 illustrates another embodiment of a lighting pendant 100 in accordance with aspects of the present disclosure. In this illustrated embodiment, the lighting pendant includes a lighting fixture 120 having a shield 150 comprising a plurality of openings 157 disposed around an ornament 180. The plurality of openings may extend through the thickness of shield 150. Plurality of openings 157 may define a pattern illuminatable by a light source 118. As shown in FIGS. 6 and 7, plurality of openings 157 may comprise a plurality of elongated openings that define a plurality of rays extending outwardly from ornament 180.

FIG. 8 illustrates another embodiment of a lighting pendant 200 in accordance with aspects of the present disclosure. In this illustrated embodiment, the lighting pendant includes lighting fixture 220 having a shield 250 comprising a plurality of openings 257 disposed around an ornament 280. The plurality of openings may extend through the thickness of shield 250. Plurality of openings 257 may define a pattern illuminatable by a light source 218. As shown in FIGS. 8 and 9, plurality of openings 257 may comprise a plurality of elongated openings that define a plurality of generally crisscrossing rays extending out from ornament 280. The crisscrossing rays may be in a diamond pattern similar to the diamond paving pattern in Michelangelo's Piazza del Campidoglio in Rome, Italy.

FIG. 10 illustrates one embodiment of a method 300 for providing illumination in accordance with aspects of the present disclosure. The method generally includes, at 310 supporting an opaque cap from a ceiling, at 320 supporting a shield, spaced-apart below the opaque cap, having an aperture having a translucent ornament disposed in the aperture, and at 330 emitting light generally from the suspended opaque cap onto the translucent ornament.

The various features of the lighting fixture described above, may be incorporated into the method for providing illumination. For example, the ornament may comprise a crystal. The emitting light may comprise emitting light in a pattern around the translucent ornament, such as though a plurality of openings disposed in the shield as described above. The pattern may comprise a plurality of rays extending out from the translucent ornament, a plurality of generally crisscrossing rays extending out from the translucent ornament, or other patterns and/or combinations thereof.

With reference to the various disclosed embodiments, the shield may comprise a generally convex lower surface. It will be appreciated that the shield may have a box-like configuration, flat configuration, or other suitable configurations, and/or combinations thereof. The cap may comprise a generally convex upper surface. In addition, it will be appreciated that the cap may have a box-like configuration, flat configuration, or other suitable configurations, and/or combinations thereof. The cap, the shield, the ornament, and the light source may be aligned along a longitudinal axis of the lighting fixture.

In the above embodiments of the lighting fixture, light may be emitted downwardly from the ornament and the plurality of openings in the shield as noted by the arrows in the figures. In addition, light may emitted upwardly toward a ceiling by being reflected off the inside surface of the shield and of a top surface of the ornament as noted by the arrows in the figures. The lighting fixture may include one or more ornaments. The ornament or ornaments may refract, emit, and/or reflect light. The ornaments may comprise a plastic, stone, metal, or glass material. The translucent or transparent ornament may comprise a tint or color, for example, blue or red, but may typically be substantially clear. The ornaments may be solid, hollow, or have passageways therethrough, and combinations thereof. The ornaments may be of any available size. In one example, the ornament may have a length of about 4.3 inched, a width of about 4.3 inches, and a height of about 2 inches. The ornaments may be a monolithic structure or comprise a one-piece construction, or formed from several separate pieces. The ornaments may be double-pointed, tetrahedrons, polyhedrons, or have other faceted configurations. The ornament or ornaments may be observable to observers when the lighting fixture is viewed from below or from below and to the side. The light source may be or may not be observable to observers when the lighting fixture is viewed from below or from below and to the side.

In the above embodiments of the lighting fixture, the cap and the shield may be formed from a transparent, opaque or non-translucent material, portions which are transparent or opaque, and combination thereof. The cap and shield may have outer colored surfaces, such as black, white, grey, or other suitable colors, and combinations thereof. The cap and shield may have different colors. The cap and the shield may be a monolithic structure or comprise a one-piece construction, or formed from several separate pieces. The plurality of openings in the shield may be extend generally along the entire shield or extend along a portion of the shield, and may be elongated, have other configurations, and combinations thereof. The cap and shield may be formed from a metallic, plastic, other suitable materials, or combinations thereof. The cap and shield may be of any available size. In one example, the cap and the shield may be formed from a material generally having a thickness of about 0.04 inch. The shape of peripherally-extending edge of the cap and the shield may be generally square, or may be circular, oval, triangular, rectangular, polygonal, or other configuration, and combinations thereof. The peripherally-extending edge of the cap and the shield may comprise a similar shape or may be different. The light source may be an LED or light emitting diode light source, incandescent, florescent, or other suitable light sources, and combinations thereof.

The various embodiments of the lighting fixture may be suitable for installation in various environments such as in dining spaces, and above counters, bars and large tables. In one aspect, the square shape of the lighting fixture may compliment the ornaments such as a square crystal. In addition, different surface colorings or finish between the cap, the shield, and the ornament may provide contrast in the lighting fixtures.

It is to be understood that the above description is intended to be illustrative, and not restrictive. For example, the above-described embodiments and/or aspects thereof may be used in combination with each other. In addition, many modifications may be made to adapt a particular situation or material to the teachings of the various embodiments without departing from their scope.

While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A lighting fixture suspendable below a ceiling, said lighting fixture comprising:
an opaque cap disposed generally over a light source and operably attachable below the ceiling;
an opaque shield spaced apart below said cap, said shield comprising at least one aperture therethrough;
at least one translucent ornament disposed in said aperture of said shield; and
wherein light emitted from the light source is directed generally towards said translucent ornament.

2. The lighting fixture of claim 1 wherein said shield comprises a first outer peripherally-extending edge, said cap comprises a second outer peripherally-extending edge, and said first outer peripherally-extending edge being larger than said second outer peripherally-extending edge.

3. The lighting fixture of claim 1 wherein said cap comprises a first height, said shield comprises a second height, and said first height being larger than said second height.

4. The lighting fixture of claim 1 further comprising a plurality of elongated members connecting said cap to said spaced-apart shield.

5. The lighting fixture of claim 4 wherein said plurality of elongated members comprises a plurality of curved elongated members.

6. The lighting fixture of claim 4 wherein said plurality of elongated members is disposed on a non-vertical angle between said cap and said shield.

7. The lighting fixture of claim 6 wherein said plurality of elongated members comprises a plurality of curved elongated members.

8. The lighting fixture of claim 1 wherein said translucent ornament comprises a crystal ornament.

9. The lighting fixture of claim 8 wherein a bottom portion of said crystal ornament extends below a bottom of said shield.

10. The lighting fixture of claim 1 wherein said shield comprises a plurality of openings extending therethrough disposed around said ornament defining a pattern, and said pattern being illuminatable by the light source.

11. The lighting fixture of claim 10 wherein said plurality of openings comprise a plurality of elongated openings.

12. The lighting fixture of claim 10 wherein said pattern defines a plurality of rays extending out from said translucent ornament.

13. The lighting fixture of claim 10 wherein said pattern comprises a plurality of generally crisscrossing rays extending out from said translucent ornament.

14. The lighting fixture of claim 1 wherein said shield comprises a generally convex lower surface.

15. The lighting fixture of claim 1 wherein said cap comprises a generally convex upper surface.

16. The lighting fixture of claim 1 wherein said shield comprises a generally convex lower surface and said cap comprises a generally convex upper surface.

17. The lighting fixture of claim 1 wherein said cap, said shield, said ornament, and the light source are aligned along a longitudinal axis of said lighting fixture.

18. A lighting fixture suspendable below a ceiling, said lighting fixture comprising:
an opaque cap disposed generally over a light source and operably attachable below the ceiling,
an opaque shield; and
a plurality of elongated members connected at one end to said cap and at a second end to said shield to support an upper portion of said shield spaced apart from a lower portion of said cap.

19. The lighting fixture of claim 18 wherein said shield comprises a first outer peripherally-extending edge, said cap comprises a second outer peripherally-extending edge, and said first outer peripherally-extending edge being larger than said second outer peripherally-extending edge.

20. The lighting fixture of claim 19 wherein said plurality of elongated members is disposed on a non-vertical angle between said cap and said shield.

21. The lighting fixture of claim 18 wherein said plurality of elongated members comprises a plurality of curved elongated members.

22. The lighting fixture of claim 18 wherein said plurality of elongated members is disposed on a non-vertical angle between said cap and said shield.

23. The lighting fixture of claim 22 wherein said plurality of elongated members comprises a plurality of curved elongated members.

24. The lighting fixture of claim 18 wherein said opaque shield comprises a plurality of openings therethrough defining a pattern in said shield, and said pattern being illuminatable by the light source.

25. The lighting fixture of claim 24 wherein said plurality of openings comprise a plurality of elongated openings.

26. The lighting fixture of claim 24 wherein said pattern defines a plurality of radially-extending elongated openings in said shield.

27. The lighting fixture of claim 24 wherein said pattern defines a plurality of generally crisscrossing elongated openings.

28. The lighting fixture of claim 18 wherein said cap comprises a generally convex upper surface.

29. The lighting fixture of claim 28 wherein said shield comprises a generally convex lower surface.

30. A lighting fixture suspendable below a ceiling, said lighting fixture comprising:
an opaque cap disposed generally over a light source and operably attachable below the ceiling,
an opaque shield spaced apart below said cap; and
wherein said shield comprising a plurality of openings therethrough defining a pattern in said shield, and said pattern being illuminatable by the light source.

31. The lighting fixture of claim 30 wherein said plurality of openings comprises a plurality of elongated openings in said shield.

32. The lighting fixture of claim 30 wherein said pattern comprises a plurality of radially-extending elongated openings in said shield.

33. The lighting fixture of claim 30 wherein said pattern comprises a plurality of generally crisscrossing elongated openings in said shield.

34. The lighting fixture of claim 30 wherein said shield comprises a generally convex lower surface.

35. A method for providing illumination, the method comprising:
emitting light onto a translucent ornament disposed in an aperture of an opaque shield from an opaque cap suspended below a ceiling and spaced above the opaque shield.

36. The method of claim 35 wherein the ornament comprises a crystal.

37. The method of claim 35 wherein the opaque shield comprises a plurality of openings therethrough defining a pattern, and the emitting light comprises emitting light through said plurality of openings.

38. The method of claim 37 wherein the pattern defines a plurality of rays extending out from the translucent ornament.

39. The method of claim 37 wherein the pattern defines a plurality of generally crisscrossing rays extending out from the translucent ornament.
